(19) United States
(12) Patent Application Publication
(10) Pub. No.: US 2008/0208793 A1
(43) Pub. Date: Aug. 28, 2008

(54) Image file searching method and electronic device

(75) Inventor: I-Yang Lee, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION, Taipei (TW)

(21) Appl. No.: 11/710,956

(22) Filed: Feb. 27, 2007

(51) Int. Cl. G06F 17/30

(52) U.S. Cl. 707/1; 707/E17.008

(57) ABSTRACT

An image file searching method includes the following steps. First, an image searching command, which includes image color searching information or image shape searching information, is received. Then, the image searching command is compared with a plurality of image files. The image color searching information or the image shape searching information is compared with image color information or image shape information of each of the image files and a comparing result is generated. Finally, at least one target image file is found from the image files according to the comparing result. In addition, an electronic device applying the image file searching method is also disclosed.

### BACKGROUND OF THE INVENTION

1. Field of Invention

The invention relates to a file searching method and, in particular, to an image file searching method and an electronic device.

2. Related Art

With the coming of the digital age, a lot of files (e.g., image files or text files) are stored in electronic devices, and there is a large demand for searching files for the purpose of browsing or editing the file. The prior art can only make a text search according to filenames of the image files. After the possible target image files are obtained, the user may browse these target image files to make verification. Thus, the prior art cannot search for the contents of the image file according to some reference other than the text itself.

However, as the number of the image files increases, the user cannot search directly according to the contents of the image file if he or she forgets the filename of the image file to be searched. Thus, the user can only sequentially browse the image files to find the desired image file, which becomes increasingly inconvenient and troublesome as the number of image files increases.

Thus, it is an important subject of the invention to provide an image file searching method capable of solving the above-mentioned problems and making a search according to the contents of the image files directly, and an electronic device applying the image file searching method.

### SUMMARY OF THE INVENTION

In view of the foregoing, the invention is to provide an image file searching method capable of making a search according to contents of image files directly, and an electronic device applying the image file searching method.

To achieve the above, an image file searching method according to the invention includes the following steps. First, an image searching command, which includes image color searching information or image shape searching information, is received. Next, the image searching command is compared with a plurality of image files. In the comparing step, the image color searching information or the image shape searching information is compared with image color information or image shape information of each of the image files, thereby generating a comparing result. Finally, at least one target image file is found from the image files according to the comparing result.

To achieve the above, the invention discloses an electronic device includes a graphic input module, a storage module and a searching module. The graphic input module receives an image searching command, which includes image color searching information or image shape searching information. The storage module stores a plurality of image files. The searching module is electrically connected to the graphic input module and the storage module and finds at least one target image file from the image files according to the image searching command.

As mentioned above, the image file searching method and the electronic device according to the invention directly search the image file content to find out the target image file according to the image searching command containing the image color searching information or the image shape searching information. Compared with the prior art, the invention enables the user to find the target image file according to the image color or the image shape without needing to remembering the filename of the desired image file, thus improving the convenience of operation. In addition, because the graphic input module of the invention can directly depict the image color or the image shape, it is simple and intuitive to input query information.

### BRIEF DESCRIPTION OF THE DRAWINGS

The invention will become more fully understood from the detailed description given herein below illustration only, and thus is not limitative of the present invention, and wherein:

FIG. 1 is a block diagram showing an electronic device according to a preferred embodiment of the invention;

FIG. 2 is a schematic illustration showing an electronic device taking image color searching information as an image searching command according to the preferred embodiment of the invention;

FIG. 3 is a schematic illustration showing an electronic device taking image shape searching information as the image searching command according to the preferred embodiment of the invention;

FIG. 4 is a block diagram showing another electronic device according to the preferred embodiment of the invention; and

FIG. 5 is a flow chart showing an image file searching method according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

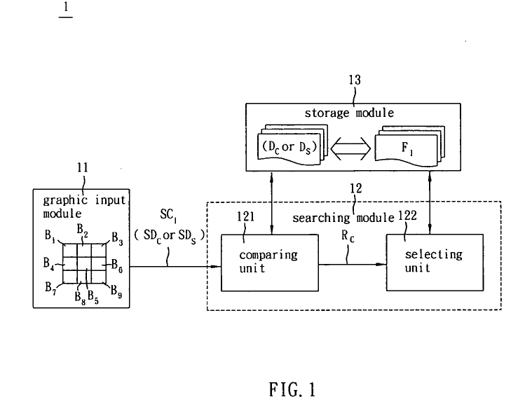

Referring to FIG. 1, an electronic device 1 according to a preferred embodiment of the invention includes a graphic input module 11, a searching module 12 and a storage module 13. The searching module 12 is electrically connected to the graphic input module 11 and the storage module 13. The storage module 13 stores a plurality of image files F_{I}. The electronic device 1 may be a computer or a mobile phone, which includes, without limitation to, a smart mobile phone.

The graphic input module 11 receives an image searching command SC_{I}, which includes image color searching information SD_{C} or image shape searching information SD_{S}. The graphic input module 11 may be implemented by hardware or software, which includes, without limitation to, a plotting board, a touch screen or graphic software. If the graphic input module 11 is a plotting board, the image searching command SC_{I} may be generated in conjunction with the input of a plotting pen. If the graphic input module 11 is a touch screen, the image searching command SC_{I} may be generated in conjunction with the input of a touch pen. If the graphic input module 11 is graphic software, the image searching command SC_{I} may be generated in conjunction with the input of a mouse or a keyboard. In addition, the image color searching information SD_{C} may consist of at least one color level, which may be represented by a red signal reference value (R), a green signal reference value (G) and a blue signal reference value (B), each of which ranges from 0 to 255. For example, if the color level (R, G, B) of the image file F_{I} is (255, 0, 0), (212, 21, 32) or (234, 21, 11), the image file F_{I} pertains to red color. If the color level (R, G, B) of the image file F_{I} is (0, 255, 0), (22, 212, 32) or (21, 232, 11), the image file F_{I} pertains to green color. If the color level (R, G, B) of the image file F_{I} is (0, 0, 255), (12, 33, 212) or (41, 12, 232), the image file F_{I} pertains to blue color. Furthermore, the graphic input module 11 may provide a plurality of graphic input blocks B₁ to B₉ for receiving the image searching command SC_{I}. The shapes, sizes, numbers and arrangements of the graphic input blocks B₁ to B₉ may be changed according to the actual design conditions. In this embodiment, the graphic input blocks B₁ to B₉ are arranged in a 3×3 array, for example. The nine graphic input blocks B₁ to B₉ may correspond to nine color levels (the image color searching information SD_{C} ).

The searching module 12 finds at least one target image file from the image files F_{I} stored in the storage module 13 according to the image searching command SC_{I}. In this embodiment, the searching module 12 has a comparing unit 121 and a selecting unit 122.

The comparing unit 121 is electrically connected to the selecting unit 122 and the storage module 13. The comparing unit 121 compares the image color searching information SD_{C} with image color information D_{C} of each of the image files F_{I} and thus generates a comparing result R_{C}. The image color information D_{C} is the color level of the color system of each of the image files F_{I}. For example, the image file F_{I} has a plurality of pixels, and the color level of each pixel is represented by a red signal reference value (R′), a green signal reference value (G′) and a blue signal reference value (B′). The red signal reference value, the green signal reference value or the blue signal reference value may range from 0 to 255. For example, if the color level (R′, G′, B′) of the image file F_{I} is (255, 0, 0), (212, 21, 32) or (234, 21, 11), the image file F_{I} pertains to red color. If the color level (R′, G′, B′) of the image file F_{I} is (0, 255, 0), (22, 212, 32) or (21, 232, 11), the image file F_{I} pertains to green color. If the color level (R′, G′, B′) of the image file F_{I} is (0, 0, 255), (12, 33, 212) or (41, 12, 232), the image file F_{I} pertains to blue color. In addition, the image file F_{I} may be divided into a plurality of regions each including a portion of the pixels. The color coordinates of some or all of the pixels in each region may be averaged or be root-mean-squared to obtain a region color level. In this embodiment, each of the image files F_{I} has nine regions corresponding to nine-region color levels to serve as the image color information D_{C} .

In addition, the comparing unit 121 in this embodiment can perform a calculation according to the image color searching information SD_{C} (nine color levels) and the image color information D_{C} (nine region color levels) of each of the image files F_{I}, so as to obtain an error corresponding to each of the image files F_{I}, and to compare the error with a threshold value to generate the comparing result R_{C}. The threshold value may be set in advance or be set by the user. For example, the comparing unit 121 may obtain nine differences by subtracting the nine color levels of the image color searching information SD_{C} from the nine region color levels of the image color information D_{C} of each of the image files F_{I}, respectively. Then, the nine differences are root-mean-squared to obtain the error corresponding to each of the image files F_{I}. Then, the error lower than the threshold value may be listed to serve as the comparing result R_{C}.

Similarly, the comparing unit 121 may also compare the image shape searching information SD_{S} with image shape information D_{S} of each of the image files F_{I} and thus generate the comparing result R_{C}. The image shape information D_{S} is the kind of the shape and the shape distribution of each of the image files F_{I}. The comparing method is similar to that mentioned hereinabove, and detailed descriptions thereof will be omitted.

The selecting unit 122 is electrically connected to the comparing unit 121 and the storage module 13, and selects the target image file from the image files F_{I} according to the comparing result R_{C}. In this embodiment, the selecting unit 122 receives the comparing result R_{C}, and selects the image file having the comparing result R_{C} with the error smaller than the threshold value as the target image file, and finally displays, through a display module (not shown), the information or the contents of the target image file for the user to open, browse or edit. The information of the target image file may include a shortcut, a stored position, a filename, a format, a date or a file size.

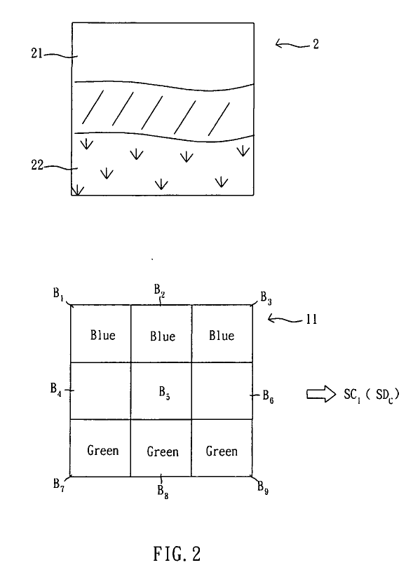

The image files may be searched according to the image color or the image shape using the searching method, which will be described in the following without limitation. Taking the search made according to the image color as an example, as shown in FIGS. 1 and 2, if the user wants to search the image file content 2 having an upper portion composed of a blue sky 21 and a lower portion composed of a green grass 22, the blue color system is selected in the graphic input blocks B₁ to B₃ of the graphic input module 11, and the green color system is selected in the graphic input blocks B₇ to B₉ of the graphic input module 11 so that the graphic input blocks B₁ to B₃ and B₇ to B₉ output the image searching command SC_{I} having the image color searching information SD_{C}. Herein, the color levels of the image color searching information SD_{C} are (0, 0, 255), (0, 0, 255), (0, 0, 255), (0, 255, 0), (0, 255, 0) and (0, 255, 0), respective to the above mentioned blocks. The image searching command SC_{I} is transferred to the comparing unit 121. The comparing unit 121 may subtract six color levels of the image color searching information SD_{C} from six region color levels of the image color information D_{C} of each of the image files F_{I} to obtain six differences, respectively, and then root-mean-squares the six differences to obtain the error corresponding to each of the image files F_{I}. Then, the error lower than the threshold value is listed to serve as the comparing result R_{C}. The selecting unit 122 receives the comparing result R_{C} and selects the image file of the comparing result R_{C} with the error below the threshold value as the target image file. Of course, the user may also set the threshold value. For example, if the set threshold value is lower, the similarity of the image color information D_{C} of the target image file to the image color searching information SD_{C} is higher.

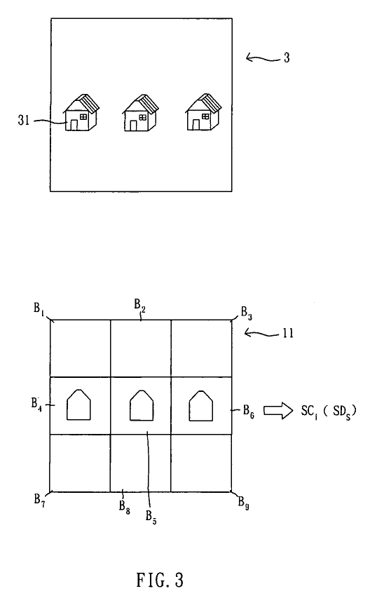

Taking the search made according to the image shape as an example, as shown in FIGS. 1 and 3, the detailed procedures will be described in the following. If the user wants to search the image file content 3 having the middle portion with the building of a house shape 31, simple house shapes are depicted in the graphic input blocks B₄ to B₆ of the graphic input module 11 so that the graphic input blocks B₄ to B₆ output the image searching command SC_{I} with the image shape searching information SD_{S}. Herein, the image shape searching information SD_{S} is composed of the kind of shape and the shape distribution. The image searching command SC_{I} is transferred to the comparing unit 121. Then, the comparing unit 121 finds out the at least one target image file from the image files F_{I} of the storage module 13 by comparing the image shape information D_{S} with the image searching command SC_{I}, and thus generates the comparing result R_{C}. The selecting unit 122 selects the target image file from the image files F_{I} according to the comparing result R_{C}.

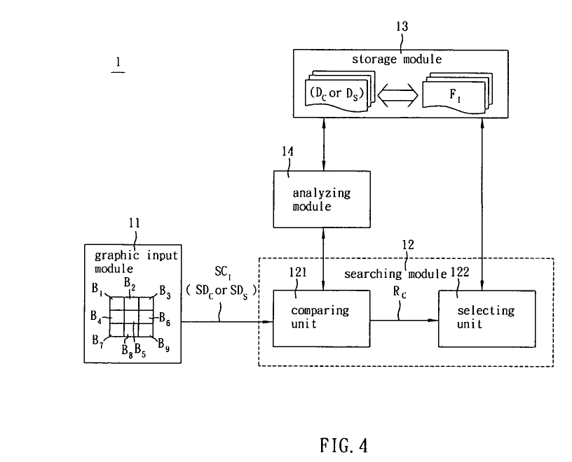

In addition, the image color information D_{C} or the image shape information D_{S} of each of the image files F_{I} may be stored in each of the image files F_{I}, or may be independently stored in a comparison table (not shown). Of course, the image color information D_{C} or the image shape information D_{S} may also be obtained through the electronic device 1 by way of the real time analysis. As shown in FIG. 4, the electronic device 1 may further include an analyzing module 14 for analyzing the image files F_{I} and thus generating the corresponding image color information D_{C} or image shape information D_{S}. The analyzing module 14 may also be integrated in the searching module 12.

The electronic device 1 finds the target image file according to the image color searching information SD_{C} or the image shape searching information SD_{S} (the image searching command SC_{I}). That is, the electronic device 1 enables the user to search the target image file according to the image color or the image shape. So, the user still can find out the target image file without having to remember the filename of the image file thus making operation more convenient. In addition, the graphic input module 11 enables the user to directly draw the image color or the image shape, avoiding the nuisance of using the touch pen or keyboard to type in information and thus enhancing the convenience of use.

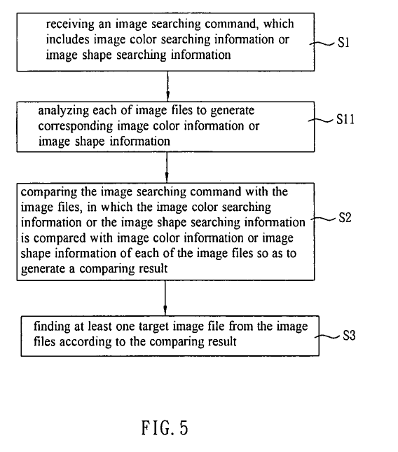

As shown in FIG. 5, an image file searching method according to the preferred embodiment of the invention includes steps S1 and S2, which may be applied to the above-mentioned electronic device 1. Step S1 receives an image searching command SC_{I}, which includes image color searching information SD_{C} or image shape searching information SD_{S}. Step S2 compares the image searching command SC_{I} with a plurality of image files F_{I}, in which the image color searching information SD_{C} or the image shape searching information SD_{S} is compared with image color information D_{C} or image shape information D_{S} of each of the image files F_{I}, and a comparing result R_{C} is thus generated. Step S3 finds at least one target image file from the plurality of image files F_{I} according to the comparing result R_{C}.

The image file searching method of this embodiment further includes step S11 before step S2. Step S11 analyzes each of the image files F_{I} to generate the corresponding image color information D_{C} or image shape information D_{S}. Because the image file searching method has been described in the electronic device 1 of the above-mentioned preferred embodiment, detailed descriptions thereof will be omitted.

In summary, the image file searching method and the electronic device according to the invention directly search the image file content to find out the target image file according to the image searching command containing the image color searching information or the image shape searching information. Compared with the prior art, the invention enables the user to find the target image file according to the image color or the image shape without needing to remembering the filename of the desired image file, thus improving the convenience of operation. In addition, because the graphic input module of the invention can directly depict the image color or the image shape, it is simple and intuitive to input query information.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An image file searching method, comprising steps of:
receiving an image searching command, which includes image color searching information or image shape searching information;
comparing the image searching command with a plurality of image files, in which the image color searching information or the image shape searching information are compared with image color information or image shape information of each of the image files, and a comparing result is thus generated; and
finding at least one target image file from the image files according to the comparing result.

2. The method according to claim 1, further comprising, before the step of comparing, a step of:
analyzing each of the image files so as to correspondingly generate the image color information or the image shape information.

3. The method according to claim 1, wherein the method is applied to an electronic device, and the image files are stored in the electronic device.

4. The method according to claim 3, wherein the electronic device is a computer or a mobile phone.

5. The method according to claim 4, wherein the mobile phone is a smart mobile phone.

6. The method according to claim 1, further comprising, before the step of receiving the image searching command, a step of:
generating the image searching command by a graphic input module.

7. The method according to claim 6, wherein the graphic input module has a plurality of graphic input blocks.

8. An electronic device, comprising:
a graphic input module for receiving an image searching command, which comprises image color searching information or image shape searching information;
a storage module for storing a plurality of image files; and
a searching module electrically connected to the graphic input module and the storage module, and finding out at least one target image file from the image files according to the image searching command.

9. The electronic device according to claim 8, wherein the searching module has a comparing unit, which is electrically connected to the graphic input module and the storage module, for comparing the image color searching information or the image shape searching information with image color information or image shape information of each of the image files and thus generating a comparing result.
information of each of the image files and thus generating a comparing result.

10. The electronic device according to claim 9, wherein the searching module further has a selecting unit electrically connected with the comparing unit and the storage module for finding out the target image file from the image files according to the comparing result.

11. The electronic device according to claim 8, further comprising:
an analyzing module for analyzing each of the image files and thus correspondingly generating the image color information or the image shape information.

12. The electronic device according to claim 11, wherein the analyzing module is integrated in the searching module.

13. The electronic device according to claim 8, wherein the graphic input module has a plurality of graphic input blocks.

14. The electronic device according to claim 8, which is a computer or a mobile phone.

15. The electronic device according to claim 14, wherein the mobile phone is a smart mobile phone.
